(19) United States
(12) Patent Application Publication
(10) Pub. No.: US 2024/0337843 A1
(43) Pub. Date: Oct. 10, 2024

(54) EYEGLASS-TYPE HEAD MOUNTED DISPLAY

(71) Applicant: SUMITOMO ELECTRIC INDUSTRIES, LTD., Osaka-shi, Osaka (JP)

(72) Inventors: Yuna OKINA, Osaka-shi (JP); Hiromi NAKANISHI, Osaka-shi (JP)

(73) Assignee: SUMITOMO ELECTRIC INDUSTRIES, LTD., Osaka-shi, Osaka (JP)

(21) Appl. No.: 18/294,773

(22) PCT Filed: Apr. 7, 2022
(86) PCT No.: PCT/JP2022/017273

§ 371 Date: Feb. 2, 2024

(30) Foreign Application Priority Data
Aug. 5, 2021 (JP) 2021-128824

(51) Int. Cl. G02B 27/01; G02C 5/22; G02C 11/00

(52) U.S. Cl. CPC G02B 27/0172; G02C 5/22; G02C 11/10; G02B 2027/0178

(57) ABSTRACT

The eyeglass-type head mounted display includes an eyeglass frame, a lens, an image generation device, and an elongated heat transfer member. The eyeglass frame includes a rim, an end piece fixed to the rim, and a temple connected to the end piece. The lens is fitted into the rim. The image generating device is fixed to the end piece, and outputs image light toward the lens. The elongated heat transfer member extends from the image generating device to the temple.

### TECHNICAL FIELD

The present disclosure relates to an eyeglass-type head mounted display. The present application claims the benefit of priority to Japanese Patent Application No. 2021-128824 filed on Aug. 5, 2021, the entire contents of which are incorporated herein by reference.

### BACKGROUND ART

Japanese Patent Laying-Open No. 2009-244869 (PTL 1) discloses an eyeglass-type head mounted display. This eyeglass-type head mounted display includes a lens, a temple coupled to the lens, and a display device. The display device includes a light source and a scanning unit that scans light emitted from the light source. The display device is held by a temple.

### CITATION LIST

### Patent Literature

PTL 1: Japanese Patent Laying-Open No. 2009-244869

### SUMMARY OF INVENTION

The eyeglass-type head mounted display of the present disclosure includes an eyeglass frame, a lens, an image generation device, and an elongated heat transfer member. The eyeglass frame includes a rim, an end piece fixed to the rim, and a temple connected to the end piece. The lens is fitted into the rim. The image generation device is fixed to the end piece and outputs image light toward the lens. The elongated heat transfer member extends from the image generation device to the temple.

### BRIEF DESCRIPTION OF DRAWINGS

FIG. 1 is a schematic view of an eyeglass-type head mounted display (when a temple is open) according to a first embodiment;

FIG. 2 is a partially enlarged schematic view of the eyeglass-type head mounted display according to the first embodiment;

FIG. 3 is a partially enlarged schematic view of a region III illustrated in FIG. 1 of the eyeglass-type head mounted display (when the temple is open) according to the first embodiment;

FIG. 4 is a schematic view of the eyeglass-type head mounted display (when the temple is closed) according to the first embodiment;

FIG. 5 is a partially enlarged schematic view of the eyeglass-type head mounted display (when the temple is closed) according to the first embodiment;

FIG. 6 is a schematic view of an eyeglass-type head mounted display (when a temple is open) according to a first modification of the first embodiment;

FIG. 7 is a partially enlarged schematic view of a region VII illustrated in FIG. 6 of the eyeglass-type head mounted display (when the temple is open) according to the first modification of the first embodiment;

FIG. 8 is a schematic view of the eyeglass-type head mounted display (when the temple is closed) according to the first modification of the first embodiment;

FIG. 9 is a partially enlarged schematic view of the eyeglass-type head mounted display (when the temple is closed) according to the first modification of the first embodiment;

FIG. 10 is a schematic diagram of an eyeglass-type head mounted display according to a second modification of the first embodiment;

FIG. 11 is a schematic diagram of an eyeglass-type head mounted display (when a temple is open) according to a second embodiment;

FIG. 12 is a schematic diagram of the eyeglass-type head mounted display (when the temple is closed) according to the second embodiment;

FIG. 13 is a schematic view of an eyeglass-type head mounted display (when a temple is open) according to a modification of the second embodiment;

FIG. 14 is a schematic view of the eyeglass-type head mounted display (when the temple is closed) according to the modification of the second embodiment;

FIG. 15 is a partially enlarged schematic view of an example of an elongated heat transfer member of the eyeglass-type head mounted display according to the modification of the second embodiment;

FIG. 16 is a partially enlarged schematic view of another example of the elongated heat transfer member of the eyeglass-type head mounted display according to the modification of the second embodiment;

FIG. 17 is a schematic diagram of an eyeglass-type head mounted display (when a temple is open) according to a third embodiment;

FIG. 18 is a partially enlarged schematic view of the eyeglass-type head mounted display according to the third embodiment;

FIG. 19 is a schematic diagram of an eyeglass-type head mounted display (when a temple is open) according to a fourth embodiment; and

FIG. 20 is a schematic enlarged cross-sectional view of a coaxial cable of the eyeglass-type head mounted display according to the fourth embodiment.

### DETAILED DESCRIPTION

### Problem to be Solved by the Present Disclosure

However, in the eyeglass-type head mounted display of PTL 1, the temperature of a portion of the temple in the vicinity of the display device becomes locally high due to the heat generated by the display device. As a result, the user feels uncomfortable when the user wears the eyeglass-type head mounted display. The present disclosure has been made in view of the above-mentioned problem, and an object thereof is to provide an eyeglass-type head mounted display which offers an improved user experience.

### Advantageous Effect of the Present Disclosure

According to the present disclosure, it is possible to provide an eyeglass-type head mounted display which offers an improved user experience.

### DESCRIPTION OF EMBODIMENTS

First, embodiments of the present disclosure will be described in a list.
(1) The eyeglass-type head mounted display 1, 1a, 1b, 1c, or 1d according to the present disclosure includes an eyeglass frame 10, a lens 19, an image generation device 20, and an elongated heat transfer member 40. The eyeglass frame 10 includes a rim 11, an end piece 14 fixed to the rim 11, and a temple 16 connected to the end piece 14. The lens 19 is fitted into the rim 11. The image generation device 20 is fixed to the end piece 14 and outputs image light toward the lens 19. The elongated heat transfer member 40 extends from the image generation device 20 to the temple 16.

The elongated heat transfer member 40 can quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1, 1a, 1b, 1c, or 1d is improved.
(2) In the eyeglass-type head mounted display 1, 1a, 1b, 1c, or 1d according to (1) in the above, a portion (portion 40a) of the elongated heat transfer member 40 is embedded in the temple 16.

The elongated heat transfer member 40 is in contact with the temple 16 over a larger area. The elongated heat transfer member 40 can quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1, 1a, 1b, 1c, or 1d is improved.
(3) In the eyeglass-type head mounted display 1, 1a, 1b, 1c, or 1d according to (1) or (2) in the above, the portion 40a of the elongated heat transfer member 40 that is in contact with the temple 16 has a length of 2.0 cm or more.

The elongated heat transfer member 40 is in contact with the temple 16 over a larger area. The elongated heat transfer member 40 can quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1, 1a, 1b, 1c, or 1d is improved.
(4) In the eyeglass-type head mounted display 1, 1a, 1b, 1c, or 1d according to any one of (1) to (3) in the above, the image generation device 20 includes a light source 22 and a support member 21 on which the light source 22 is mounted. The elongated heat transfer member 40 is fixed to the support member 21.

During the operation of the light source 22, the light source 22 generates heat. The light source 22 is a component of the image generation device 20 that has a higher temperature. The elongated heat transfer member 40 can quickly spread the heat generated by the light source 22 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1, 1a, 1b, 1c, or 1d is improved.
(5) In the eyeglass-type head mounted display 1, 1b, 1c, or 1d according to any one of (1) to (4) in the above, the eyeglass frame 10 further includes a hinge 15. The temple 16 is connected to the end piece 14 via the hinge 15.

The elongated heat transfer member 40 can quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1, 1b, 1c, or 1d is improved. By closing the temple 16, the eyeglass-type head mounted display 1, 1b, 1c, or 1d can be easily carried and stored.
(6) The eyeglass-type head mounted display 1 or 1d according to (5) in the above further includes a coupling member 50 that increases a coupling force between the elongated heat transfer member 40 and the image generation device 20 when the temple 16 is open.

The coupling member 50 prevents the elongated heat transfer member 40 from being unintentionally separated from the image generation device 20 when the temple 16 is open. The elongated heat transfer member 40 can stably and quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1 or 1d is improved.
(7) In the eyeglass-type head mounted display 1 or 1d according to (6) in the above, the coupling member 50 is a magnet 51 or 52 disposed in at least one of the elongated heat transfer member 40 or the image generation device 20.

The magnets 51 and 52 can prevent the elongated heat transfer member 40 from being unintentionally separated from the image generation device 20 when the temple 16 is open. The elongated heat transfer member 40 can stably and quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1 or 1d is improved.
(8) In the eyeglass-type head mounted display 1 according to (6), the coupling member 50 includes a recess 51a which is formed in one of the elongated heat transfer member 40 and the image generation device 20, and a protrusion 52a which is formed in the other of the elongated heat transfer member 40 and the image generation device 20 and engages with the recess 51a when the temple 16 is open.

The recess 51a and the protrusion 52a can prevent the elongated heat transfer member 40 from being unintentionally separated from the image generation device 20 when the temple 16 is open. The elongated heat transfer member 40 can stably and quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1 is improved.
(9) In the eyeglass-type head mounted display 1, 1a, or 1d according to any one of (1) to (8) in the above, the elongated heat transfer member 40 is a heat transfer pipe 41, a heat transfer rod, or a heat transfer plate.

The heat transfer pipe 41, the heat transfer rod or the heat transfer plate can quickly spread the heat generated by the image generation device 20 to the temple 16. The heat transfer pipe 41, the heat transfer rod or the heat transfer plate can prevent the temperature of the portion of the eyeglass frame 10 in the vicinity of the image generation device 20 from becoming locally high. Therefore, the user experience when wearing the eyeglass-type head mounted display 1, 1a, or 1d is improved.
(10) In the eyeglass-type head mounted display 1b according to (5) in the above, at least a portion (for example, the heat transfer sheet 42 or the bendable heat transfer component 45) of the elongated heat transfer member 40 is bendable.

Even though the temple 16 is rotated about the hinge 15, the bendable elongated heat transfer member 40 remains in contact with the image generation device 20 and the temple 16. The elongated heat transfer member 40 can stably and quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1b is improved.
(11) In the eyeglass-type head mounted display 1c according to (5) in the above, the hinge 15 includes a hinge pin 15a. The elongated heat transfer member 40 includes a first heat transfer component 47, a second heat transfer component 48, and the hinge pin 15a. The first heat transfer component 47 extends from the image generation device 20 to the hinge pin 15a. The second heat transfer component 48 extends from the hinge pin 15a to the temple 16.

Even if the temple 16 is rotated about the hinge 15, the first heat transfer component 47 and the second heat transfer component 48 remain in contact with the image generation device 20 and the temple 16. The first heat transfer component 47 and the second heat transfer component 48 are connected to the hinge pin 15a. The elongated heat transfer member 40 can stably and quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1c is improved.
(12) In the eyeglass-type head mounted display 1a according to any one of (1) to (4) in the above, the end piece 14 and the temple 16 are integrated with each other as a single member.

The elongated heat transfer member 40 can quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1a is improved.
(13) In the eyeglass-type head mounted display 1, 1a, 1b, 1c, or 1d according to any one of (1) to (12) in the above, the elongated heat transfer member 40 has a higher thermal conductivity than the temple 16.

The elongated heat transfer member 40 can quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1, 1a, 1b, 1c, or 1d is improved.
(14) In the eyeglass-type head mounted display 1, 1a, 1b, 1c, or 1d according to any one of (1) to (12) in the above, the elongated heat transfer member 40 has a thermal conductivity of 1.0 W/(m·K) or more.

The elongated heat transfer member 40 can quickly spread the heat generated by the image generation device 20 to the temple 16. The elongated heat transfer member 40 can prevent the temperature of a portion of the eyeglass frame 10 in the vicinity of the image generation device 20 from becoming locally high. Therefore, the user experience when wearing the eyeglass-type head mounted display 1, 1a, 1b, 1c, or 1d is improved.
(15) The eyeglass-type head mounted display 1d according to any one of (1) to (14) in the above further includes a driver circuit 31 that is fixed to the eyeglass frame 10 and controls the image generation device 20, and a coaxial cable 62. The coaxial cable 62 includes a signal wire 63 that is electrically connected to the driver circuit 31, and at least one of a shield 67 or a heat transfer wire 65. The shield 67 surrounds the signal wire 63. At least one of the shield 67 or the heat transfer wire 65 is connected to the elongated heat transfer member 40.

The elongated heat transfer member 40 can rapidly spread the heat generated by the image generation device 20 to the temple 16 and at least one of the shield 67 or the heat transfer wire 65. The elongated heat transfer member 40 can prevent the temperature of a portion of the eyeglass frame 10 in the vicinity of the image generation device 20 from becoming locally high. Therefore, the user experience when wearing the eyeglass-type head mounted display 1d is improved.

### Details of Embodiments

Hereinafter, embodiments of the present disclosure will be described in detail with reference to the drawings. In the following drawings, the same or equivalent portions will be denoted by the same reference numerals, and the description thereof will not be repeated. Note that at least a part of the embodiments described below may be arbitrarily combined in any combination.

### First Embodiment

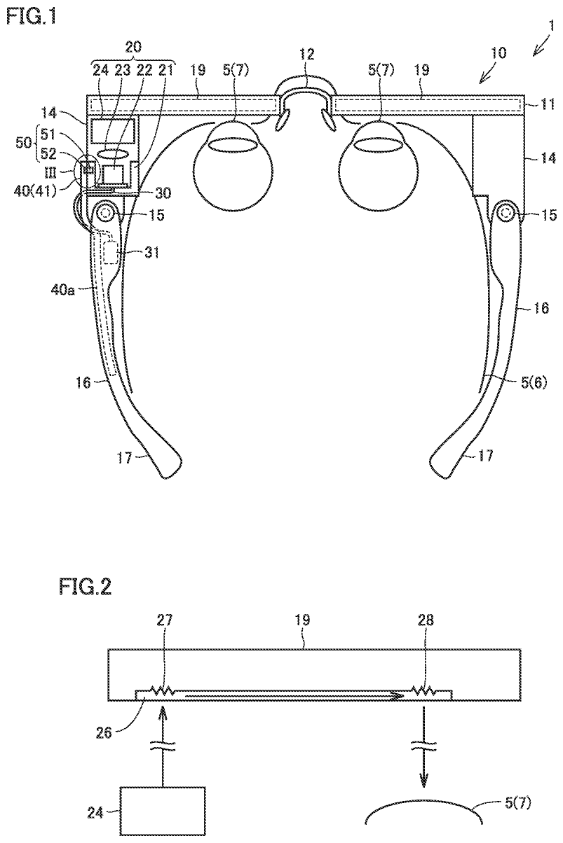

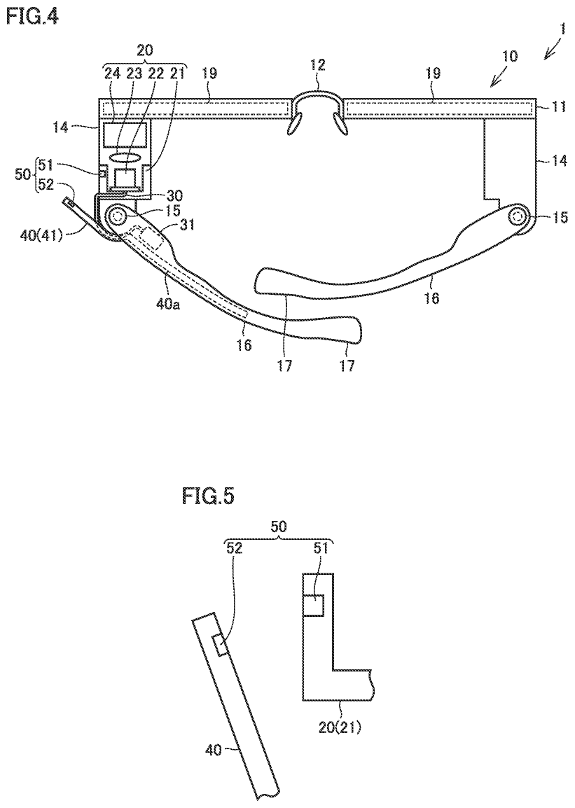

An eyeglass-type head mounted display 1 according to a first embodiment will be described with reference to FIGS. 1 to 5. The eyeglass-type head mounted display 1 is mounted on a head 6 of a user 5. The eyeglass-type head mounted display 1 mainly includes an eyeglass frame 10, a lens 19, an image generation device 20, and an elongated heat transfer member 40. The eyeglass-type head mounted display 1 may further include a driver circuit 31, an electrical wire 30, and a coupling member 50.

The eyeglass frame 10 is made of a metal such as titanium, aluminum or stainless steel, or a resin such as celluloid, acetate, polyether imide, polyamide or polyphenyl sulfone. The eyeglass frame 10 includes a rim 11, a bridge 12, an end piece 14, a hinge 15, a temple 16, and a temple tip 17.

The rim 11 supports the lens 19. The bridge 12 connects a pair of rims 11 and 11 to each other. The end piece 14 is fixed to the rim 11. The temple 16 is connected to the end piece 14 via the hinge 15. Therefore, the temple 16 can rotate about the hinge 15 with respect to the end piece 14 and can be opened and closed. The length of the temple 16 in the longitudinal direction of the temple 16 (the vertical direction in the paper of FIG. 1) is larger than the length of the end piece 14 in the thickness direction of the rim 11 (the vertical direction in the paper of FIG. 1). The temple tip 17 is provided at the distal end of the temple 16 relative to the end piece 14. When the eyeglass-type head mounted display 1 is mounted on the head 6 of the user 5, the temple tip 17 is hung on the ear of the user 5.

The lens 19 is fitted into the rim 11, and is supported by the rim 11. The lens 19 is a transparent member. The ambient light passes through the lens 19 and reaches an eye 7 of the user 5. The lens 19 is provided with a light guide 26. The light guide 26 is provided with light direction conversion elements 27 and 28. Each of the light direction conversion elements 27 and 28 is, for example, a grating. The light direction conversion element 27 converts the direction of image light output from the image generation device 20. The image light travels through the light guide 26. The light direction conversion element 28 converts the direction of the image light and directs the image light to the eye 7 of the user 5.

The image generation device 20 is fixed to the end piece 14. The image generation device 20 outputs image light toward the lens 19. The image generation device 20 includes, for example, a light source 22 and a support member 21. The image generation device 20 may further include a lens 23 and a spatial light modulator 24.

The light source 22 is, for example, a semiconductor light emitting element such as a laser diode (LD) or a light emitting diode (LED). The light source 22 may include, for example, a red laser diode (not shown), a green laser diode (not shown), a blue laser diode (not shown), and an optical combiner (not shown). The optical combiner combines a red laser light output from the red laser diode, a green laser light output from the green laser diode, and a blue laser light output from the blue laser diode.

The light source 22 is mounted on the support member 21. The support member 21 is made of, for example, a metal such as aluminum or copper, an alloy such as brass, a zinc-iron alloy or a copper-tungsten alloy, or a ceramic such as aluminum nitride. The lens 23 collimates the light emitted from the light source 22, for example. The spatial light modulator 24 modulates the light emitted from the light source 22 to generate image light. The spatial light modulator 24 is, for example, a liquid crystal spatial light modulator such as LCOS (Liquid crystal on silicon) or a MEMS (microelectromechanical system) spatial light modulator.

The elongated heat transfer member 40 refers to such a heat transfer member that has an elongated shape in a plan view from a direction (a direction perpendicular to the paper of FIG. 1) perpendicular to both the arrangement direction of the rim 11 (the horizontal direction in the paper of FIG. 1) and the thickness direction of the rim 11 (the vertical direction in the paper of FIG. 1). The elongated heat transfer member 40 is, for example, a rigid heat transfer member. The elongated heat transfer member 40 is, for example, a heat transfer pipe 41. The elongated heat transfer member 40 may be a heat transfer rod or a heat transfer plate. The length of the elongated heat transfer member 40 in the longitudinal direction (the vertical direction in the paper of FIG. 1) of the elongated heat transfer member 40 is larger than the length of the support member 21 in the thickness direction (the vertical direction in the paper of FIG. 1) of the rim 11. The length of the elongated heat transfer member 40 in the longitudinal direction of the elongated heat transfer member 40 may be larger than the length of the image generation device 20 in the thickness direction of the rim 11 (the vertical direction in the paper of FIG. 1).

The elongated heat transfer member 40 is made of, for example, a metal such as copper, aluminum or iron, an alloy such as stainless steel or zinc-iron alloy, a ceramic such as aluminum nitride, or carbon. The elongated heat transfer member 40 may have a higher thermal conductivity than the temple 16. The elongated heat transfer member 40 has a thermal conductivity of, for example, 1.0 W/(m·K) or more. The elongated heat transfer member 40 may have a thermal conductivity of 3.0 W/(m·K) or more, may have a thermal conductivity of 5.0 W/(m·K) or more, may have a thermal conductivity of 7.0 W/(m·K) or more, or may have a thermal conductivity of 10.0 W/(m·K) or more.

A portion (portion 40a) of the elongated heat transfer member 40 is in contact with the temple 16. Specifically, a portion (portion 40a) of the elongated heat transfer member 40 is embedded in the temple 16. A portion (portion 40a) of the elongated heat transfer member 40 may be provided on the temple 16. The portion 40a of the elongated heat transfer member 40 which is in contact with the temple 16 has a length of, for example, 2.0 cm or more. The portion 40a of the elongated heat transfer member 40 which is in contact with the temple 16 may have a length of 3.0 cm or more, or 5.0 cm or more. In the present specification, the fact that a portion (portion 40a) of the elongated heat transfer member 40 is in contact with the temple 16 means that a portion (portion 40a) of the elongated heat transfer member 40 is in direct contact with the temple 16 or a portion (portion 40a) of the elongated heat transfer member 40 is in contact with the temple 16 via an adhesive agent or an adhesive tape.

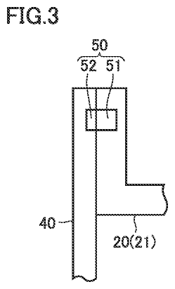

With reference to FIGS. 1 and 3, when the temple 16 is open, the elongated heat transfer member 40 is in contact with the image generation device 20 (for example, the support member 21). The elongated heat transfer member 40 extends from the image generation device 20 (for example, the support member 21) to the temple 16.

The coupling member 50 increases the coupling force between the elongated heat transfer member 40 and the image generation device 20 (for example, the support member 21) when the temple 16 is open. Specifically, the coupling member 50 is a magnet 51, 52 disposed in at least one of the elongated heat transfer member 40 (for example, the support member 21) or the image generation device 20. In the present embodiment, the magnet 51 is disposed in the image generation device 20 (for example, the support member 21), and the magnet 52 is disposed in the elongated heat transfer member 40. When the temple 16 is open, the magnets 51 and 52 are attracted to each other, which increases the coupling force between the elongated heat transfer member 40 and the image generation device 20 (for example, the support member 21). When the temple 16 is closed, the magnets 51 and 52 are separated from each other. When one of the elongated heat transfer member 40 and the support member 21 is made of a magnetic material, a magnet may be disposed only in the other of the elongated heat transfer member 40 and the support member 21.

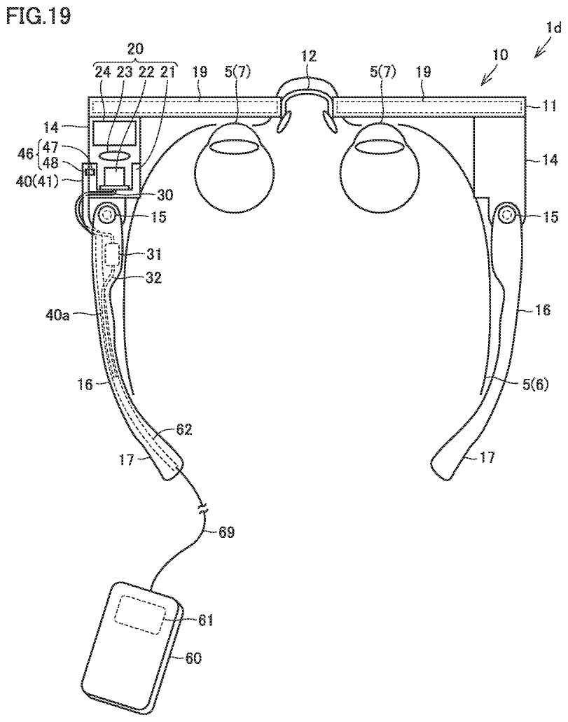

The driver circuit 31 is fixed to the eyeglass frame 10. The driver circuit 31 may be fixed to the temple 16, for example. The driver circuit 31 drives the image generation device 20. Specifically, the driver circuit 31 can communicate with the image signal generation circuit 61 (see FIG. 19) via an electrical wire 32 (see FIG. 19) or can communicate with the image signal generation circuit 61 wirelessly. The driver circuit 31 receives an image signal output from the image signal generation circuit 61, and generates a drive signal to drive the image generation device 20 (for example, the light source 22 and the spatial light modulator 24). The drive signal is input to the image generation device 20 (for example, the light source 22 and the spatial light modulator 24).

The electrical wire 30 is connected to the image generation device 20 and the driver circuit 31. The drive signal generated by the driver circuit 31 propagates through the electrical wire 30 and is input to the image generation device 20 (for example, the light source 22 and the spatial light modulator 24). In the present embodiment, the electrical wire 30 is disposed below the elongated heat transfer member 40. The image generation device 20 (for example, the light source 22 and the spatial light modulator 24) is driven by the drive signal to output the image light toward the lens 19.

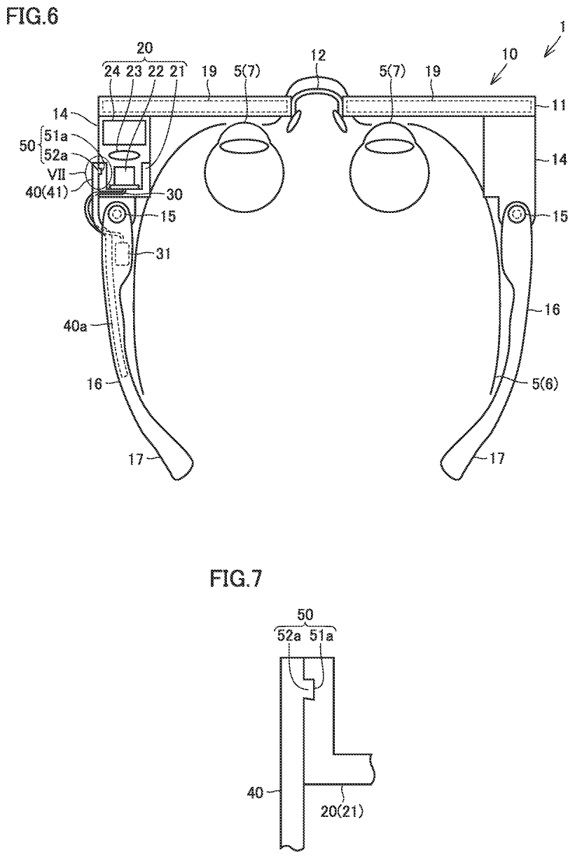

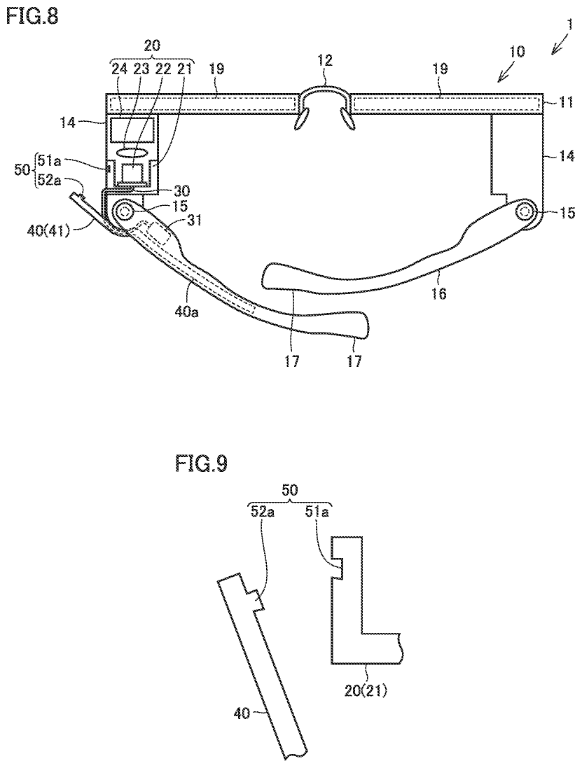

With reference to FIGS. 6 to 9, in the eyeglass-type head mounted display 1 according to a first modification of the present embodiment, the coupling member 50 may include a recess 51a which is formed in the image generation device 20 (for example, the support member 21) and a protrusion 52a which is formed in the elongated heat transfer member 40 and engages with the recess 51a when the temple 16 is open. When the temple 16 is closed, the protrusion 52a is separated from the recess 51a. The recess 51a may be formed in the elongated heat transfer member 40, and the protrusion 52a may be formed in the image generation device 20 (for example, the support member 21).

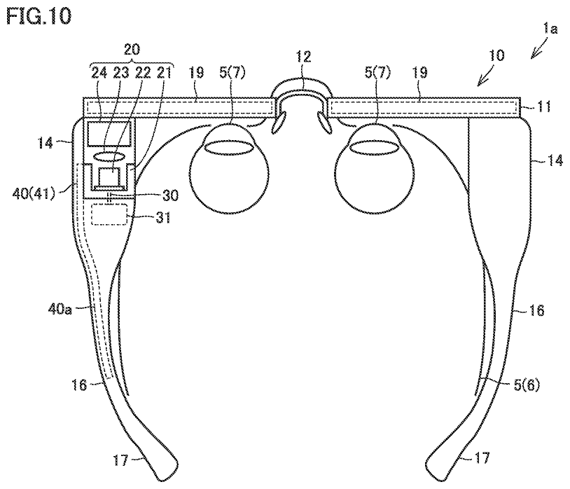

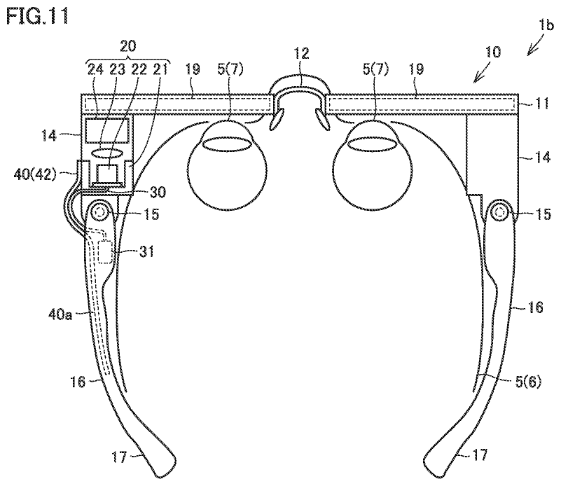

With reference to FIG. 10, in the eyeglass-type head mounted display 1a according to a second modification of the present embodiment, the end piece 14 and the temple 16 may be integrated with each other as a single member. In the second modification of the present embodiment, the temple 16 is, for example, a portion of the single member behind the image generation device 20.

### Second Embodiment

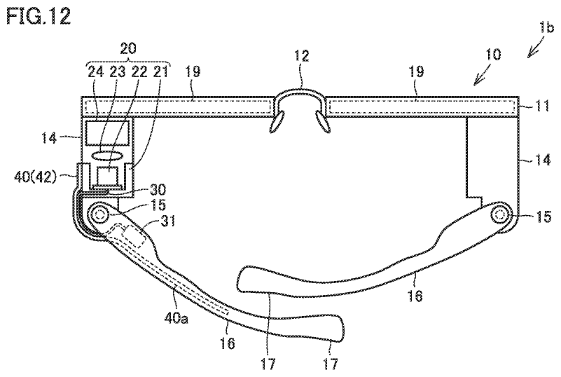

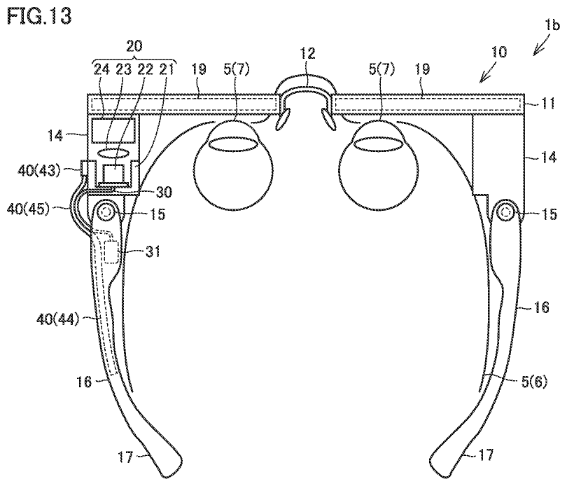

An eyeglass-type head mounted display 1b according to a second embodiment will be described with reference to FIGS. 11 and 12. The eyeglass-type head mounted display 1b of the present embodiment has a configuration similar to that of the eyeglass-type head mounted display 1 of the first embodiment, but is mainly different in the following points.

In the eyeglass-type head mounted display 1b, the elongated heat transfer member 40 is bendable. The elongated heat transfer member 40 is a bendable heat transfer sheet 42 such as a copper foil or an aluminum foil. The heat transfer sheet 42 is attached to the image generation device 20 (for example, the support member 21) using, for example, a thermally conductive adhesive agent (not shown) such as an epoxy resin adhesive agent containing a filler such as silicon oxide or aluminum oxide, or a thermally conductive adhesive tape (not shown) such as an acrylic adhesive tape.

The coupling member 50 (illustrated in FIGS. 1 to 9) is not provided in the eyeglass-type head mounted display 1b. The electrical wire 30 is disposed between the elongated heat transfer member 40 and the side surface of the end piece 14. The electrical wire 30 extends along the side surface of the end piece 14.

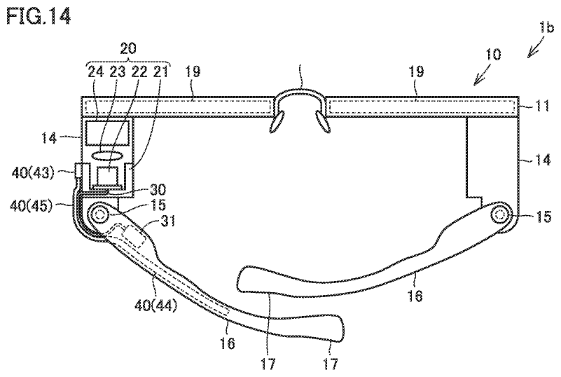

With reference to FIGS. 13 to 16, in the eyeglass-type head mounted display 1b according to a modification of the present embodiment, a portion of the elongated heat transfer member 40 is bendable. The elongated heat transfer member 40 includes, for example, a first rigid heat transfer component 43, a second rigid heat transfer component 44, and a bendable heat transfer component 45. Each of the first rigid heat transfer component 43 and the second rigid heat transfer component 44 is, for example, a heat transfer pipe, a heat transfer rod, or a heat transfer plate. The first rigid heat transfer component 43 is attached to the image generation device 20 (for example, the support member 21) using, for example, a thermally conductive adhesive agent (not shown) such as an epoxy resin adhesive agent containing a filler such as silicon oxide or aluminum oxide, or a thermally conductive adhesive tape (not shown) such as an acrylic adhesive tape. The second rigid heat transfer component 44 is in contact with the temple 16. Specifically, the second rigid heat transfer component 44 may be embedded in the temple 16 or may be provided on the temple 16.

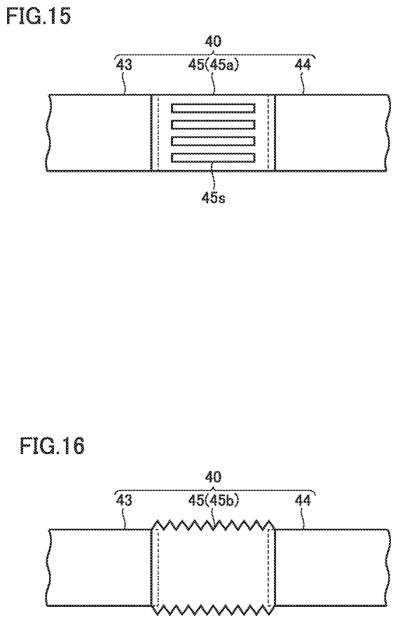

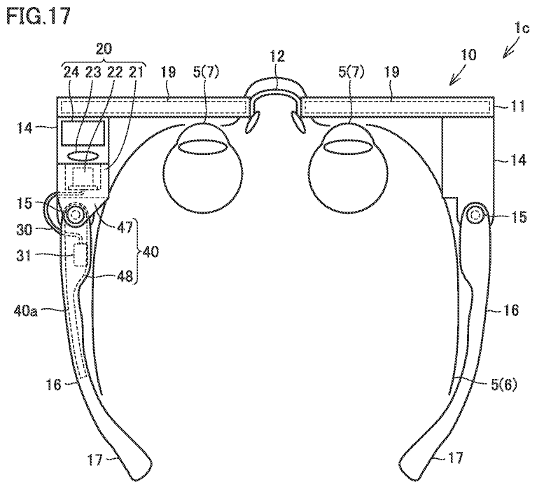

The bendable heat transfer component 45 is connected to both the first rigid heat transfer component 43 and the second rigid heat transfer component 44. The bendable heat transfer component 45 may be, for example, a bendable heat transfer sheet 45a (see FIG. 15) such as a copper foil or an aluminum foil, or may be a metal bellows 45b (see FIG. 16). As illustrated in FIG. 15, the heat transfer sheet 45a may be formed with slits 45s. The slits 45s makes the heat transfer sheet 45a further bendable.

### Third Embodiment

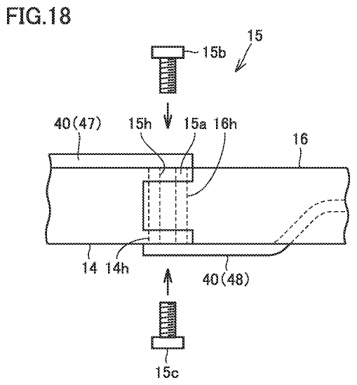

An eyeglass-type head mounted display 1c according to a third embodiment will be described with reference to FIGS. 17 and 18. The eyeglass-type head mounted display 1c of the present embodiment has a configuration similar to that of the eyeglass-type head mounted display 1 of the first embodiment, but is mainly different in the following points.

In the eyeglass-type head mounted display 1c, the hinge 15 includes a hinge pin 15a and fixing members 15b and 15c. The end piece 14 is provided with a hole 14h. The temple 16 is provided with a hole 16h. The hole 16h is coaxial with the hole 14h. The hinge pin 15a is inserted into the hole 14h and the hole 16h. The hinge pin 15a is made of metal, for example. The hinge pin 15a is provided with, for example, a screw hole 15h. The fixing members 15b and 15c are, for example, screws. The fixing members 15b and 15c are screwed into the screw hole 15h of the hinge pin 15a, for example. The fixing members 15b and 15c fix the hinge pin 15a to the end piece 14. The temple 16 is rotatable about the hinge 15, and is openable and closable.

The elongated heat transfer member 40 includes a first heat transfer component 47, a second heat transfer component 48, and a hinge pin 15a.

The first heat transfer component 47 is, for example, a heat transfer plate, a heat transfer pipe, or a heat transfer rod. The first heat transfer component 47 extends from the image generation device 20 (for example, the support member 21) to the hinge pin 15a. The first heat transfer component 47 is fixed to the end piece 14 using the fixing member 15b. The first heat transfer component 47 may be fixed to the end piece 14 using a thermally conductive adhesive agent (not shown), a thermally conductive adhesive tape (not shown), or the like. A portion of the first heat transfer component 47 is disposed, for example, on the upper surface of the end piece 14. The first heat transfer component 47 may extend over the entire width of the support member 21 in the arrangement direction of the rim 11 (the horizontal direction in the paper of FIG. 17). The first heat transfer component 47 may cover the entire support member 21 in the arrangement direction of the rim 11 (the horizontal direction in the paper of FIG. 17) and the thickness direction of the rim 11 (the vertical direction in the paper of FIG. 17).

The second heat transfer component 48 has an elongated shape. The second heat transfer component 48 is, for example, a heat transfer plate, a heat transfer pipe, or a heat transfer rod. The second heat transfer component 48 extends from the hinge pin 15a to the temple 16. The second heat transfer component 48 is fixed to the temple 16 using the fixing member 15c. The second heat transfer component 48 may be fixed to the temple 16 using a thermally conductive adhesive agent (not shown), a thermally conductive adhesive tape (not shown), or the like. The second heat transfer component 48 is in contact with the temple 16. Specifically, a portion of the second heat transfer component 48 may be embedded in the temple 16 and the remainder of the second heat transfer component 48 exposed from the temple 16 may be disposed on the lower surface of the temple 16. The entire second heat transfer component 48 may be exposed from the temple 16 and may be provided on the temple 16.

### Fourth Embodiment

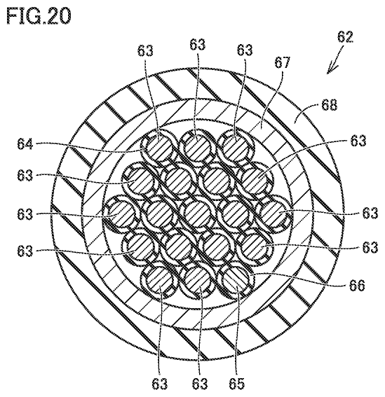

An eyeglass-type head mounted display 1d according to a fourth embodiment will be described with reference to FIGS. 19 and 20. The eyeglass-type head mounted display 1d of the present embodiment has a configuration similar to that of the eyeglass-type head mounted display 1 of the first embodiment, but is mainly different in the following points. The eyeglass-type head mounted display 1d further includes an electrical wire 32 and a coaxial cable 62.

The electrical wire 32 is connected to the driver circuit 31. The electrical wire 32 is embedded in the temple 16 and extends along the elongated heat transfer member 40.

The coaxial cable 62 is connected to an electrical wire 69. The electrical wire 69 is connected to a controller 60. The user 5 operates the controller 60 to control the eyeglass-type head mounted display 1d. The controller 60 includes an image signal generation circuit 61. The coaxial cable 62 is connected to the elongated heat transfer member 40 and the electrical wire 32. With reference to FIG. 20, the coaxial cable 62 includes signal wires 63, a shield 67, a heat transfer wire 65, and an insulating covering layer 68.

The signal wires 63 are connected to the electrical wire 32. The signal wires 63 are connected to the driver circuit 31 via the electrical wire 32. The image signal generated by the image signal generation circuit 61 propagates through the signal wires 63 and the electrical wire 32, and is input to the driver circuit 31. Each of the signal wire 63 is covered with an insulating layer 64.

The heat transfer wire 65 is connected to the elongated heat transfer member 40. The heat transfer wire 65 is made of, for example, a metal such as aluminum or copper, or an alloy such as brass, a zinc-iron alloy, or a copper-tungsten alloy. The heat transfer wire 65 may have a higher thermal conductivity than the temple 16. The heat transfer wire 65 has a thermal conductivity of, for example, 1.0 W/(m·K) or more. The heat transfer wire 65 may have a thermal conductivity of 3.0 W/(m·K) or more, may have a thermal conductivity of 5.0 W/(m·K) or more, may have a thermal conductivity of 7.0 W/(m·K) or more, or may have a thermal conductivity of 10.0 W/(m·K) or more. The heat transfer wire 65 is covered with an insulating layer 66.

The shield 67 surrounds the signal wire 63. The shield 67 shields the signal wire 63 from electrical noise. The shield 67 may further surround the heat transfer wire 65. The shield 67 is, for example, a braided shield formed by braiding copper wires, iron wires, or aluminum wires. The shield 67 is connected to the elongated heat transfer member 40. The insulating covering layer 68 covers the shield 67. The insulating covering layer 68 is made of, for example, an insulating resin such as nylon.

One of the heat transfer wire 65 and the shield 67 may not be provided. The coaxial cable 62 may be detachable from the elongated heat transfer member 40 and the electrical wire 32. The electrical wire 69 may be detachable from the coaxial cable 62.

It should be understood that the first to fourth embodiments and the modifications thereof disclosed herein have been presented for the purpose of illustration and description but not limited in all aspects. It is intended that the scope of the present invention is not limited to the description above but defined by the scope of the claims and encompasses all modifications equivalent in meaning and scope to the claims.

### REFERENCE SIGNS LIST

1, 1a, 1b, 1c, 1d: eyeglass-type head mounted display; 5: user; 6: head; 7: eye; 10: eyeglass frame; 11: rim; 12: bridge; 14: end piece; 14h: hole; 15: hinge; 15a: pin; 15b, 15c: fixing member; 15h: hole; 16: temple; 16h: hole; 17: temple tip; 19: lens; 20: image generation device; 21: support member; 22: light source; 23: lens; 24: spatial light modulator; 26: light guide; 27, 28: light direction conversion element; 30, 32: electrical wire; 31: driver circuit; 40: elongated heat transfer member; 40a: portion; 41: heat transfer pipe; 42: heat transfer sheet; 43: first rigid heat transfer component; 44: second rigid heat transfer component; 45: bendable heat transfer component; 45a: heat transfer sheet; 47: first heat transfer component; 48: second heat transfer component; 50: coupling member; 51, 52: magnet; 51a: recess; 52a: protrusion; 60: controller, 61: image signal generation circuit; 62: coaxial cable; 63: signal wire; 64, 66: insulating layer; 65: heat transfer wire; 67: shield; 68: insulating coating layer, 69: electrical wire

1. An eyeglass-type head mounted display comprising:
an eyeglass frame that includes a rim, an end piece fixed to the rim, and a temple connected to the end piece;
a lens that is fitted into the rim;
an image generation device that is fixed to the end piece and outputs image light toward the lens; and
an elongated heat transfer member that extends from the image generation device to the temple.

2. The eyeglass-type head mounted display according to claim 1, wherein
a portion of the elongated heat transfer member is embedded in the temple.

3. The eyeglass-type head mounted display according to claim 1, wherein
a portion of the elongated heat transfer member that is in contact with the temple has a length of 2.0 cm or more.

4. The eyeglass-type head mounted display according to claim 1, wherein
the image generation device includes a light source, and a support member on which the light source is mounted, and
the elongated heat transfer member is fixed to the support member.

5. The eyeglass-type head mounted display according to claim 1, wherein
the eyeglass frame further includes a hinge, and
the temple is connected to the end piece via the hinge.

6. The eyeglass-type head mounted display according to claim 5, further comprising:
a coupling member that increases a coupling force between the elongated heat transfer member and the image generation device when the temple is open.

7. The eyeglass-type head mounted display according to claim 6, wherein
the coupling member is a magnet disposed in at least one of the elongated heat transfer member or the image generation device.

8. The eyeglass-type head mounted display according to claim 6, wherein
the coupling member includes a recess which is formed in one of the elongated heat transfer member and the image generation device, and a protrusion which is formed in the other of the elongated heat transfer member and the image generation device and engages with the recess when the temple is open.

9. The eyeglass-type head mounted display according to claim 1, wherein
the elongated heat transfer member is a heat transfer pipe, a heat transfer rod, or a heat transfer plate.

10. The eyeglass-type head mounted display according to claim 5, wherein
at least a portion of the elongated heat transfer member is bendable.

11. The eyeglass-type head mounted display according to claim 5, wherein
the hinge includes a hinge pin,
the elongated heat transfer member includes a first heat transfer component, a second heat transfer component, and the hinge pin,
the first heat transfer component extends from the image generation device to the hinge pin, and
the second heat transfer component extends from the hinge pin to the temple.

12. The eyeglass-type head mounted display according to claim 1, wherein
the end piece and the temple are integrated with each other as a single member.

13. The eyeglass-type head mounted display according to claim 1, wherein
the elongated heat transfer member has a higher thermal conductivity than the temple.

14. The eyeglass-type head mounted display according to claim 1, wherein
the elongated heat transfer member has a thermal conductivity of 1.0 W/(m·K) or more.

15. The eyeglass-type head mounted display according to claim 1, further comprising:
a driver circuit that is fixed to the eyeglass frame and controls the image generation device; and
a coaxial cable,
wherein the coaxial cable includes a signal wire that is electrically connected to the driver circuit, and at least one of a shield or a heat transfer wire,
the shield surrounds the signal wire, and
the at least one of the shield or the heat transfer wire is connected to the elongated heat transfer member.
